(19) United States
(12) Patent Application Publication
(10) Pub. No.: US 2009/0311570 A1
(43) Pub. Date: Dec. 17, 2009

(54) SOFC Double Seal with Dimensional Control for Superior Thermal Cycle Stability

(75) Inventors: Yeong-Shyung Chou, Richland, WA (US); Jeffry W. Stevenson, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/481,804

(22) Filed: Jun. 10, 2009

Related U.S. Application Data
(60) Provisional application No. 61/073,109, filed on Jun. 17, 2008.
(60) Provisional application No. 61/073,456, filed on Jun. 18, 2008.

(51) Int. Cl. H01M 8/10; F16J 15/02

(52) U.S. Cl. 429/30; 277/650

(57) ABSTRACT

A seal for devices such as a solid oxide fuel cells. The seal is a double seal having a first sealing material having a first preselected characteristic and a second sealing material having a second sealing characteristic. In one embodiment of the invention the first sealing material is a compressive sealing material and the second sealing material is a hermetic sealing material. In some embodiments a dimensional stabilizer may also be included as a part of the seal. In use these double seals provide superior thermal cycling stability in electrochemical devices where gasses must be separated from each other.

### PRIORITY

This invention claims priority from provisional patent applications No. 61/073,109 filed Jun. 17, 2008 and 61/073,456 filed Jun. 18, 2009 the contents of each are herein incorporated by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

1. Field of the Invention

The invention generally relates to fuel cells and more particularly to seals for fuel cells such as solid oxide fuel cells.

2. Background Information

High temperature electromechanical devices such as solid oxide fuel cells (SOFC) require a critical seal to separate different materials such as gasses. However, as these seals under go successive thermal cycling during routine operations they can become brittle and break. In addition, these seals must be able to have a sufficient amount of mechanical strength so as to withstand the structural strains required by typical use. While various materials have been attempted in trying to provide a seal that provides for these properties, an acceptable material has not as of yet been provided. The present invention however provides a seal that overcomes at least one of these sealing problems.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present invention is a seal for device such as a solid oxide fuel cell. The seal is a double seal having a first sealing material having a first preselected characteristic and a second sealing material having a second sealing characteristic. In one embodiment of the invention the first sealing material is a compressive sealing material and the second sealing material is a hermetic sealing material. Examples of this embodiment include those applications wherein the compressive sealing material is a mica-based seal and the hermetic sealing material is a glass sealing material. In other applications and embodiments the compressive material may be any material that can withstand the associated mechanical and thermal stresses. These include materials such as expanded vermiculite, graphite, and composites containing each. The hermetic sealing material can be any material that provides an appropriate gas-tight seal under the associated conditions these include glass materials, brazes or metallic composites containing brazing material.

In some embodiments a dimensional stabilizer may also be included as a part of the seal. Examples of materials that could serve as dimensional stabilizers include metal oxides such as Al2O3, MgO and ZrO2; as well as other materials such as simple or complex oxides which have melting temperatures higher than the general operation conditions for solid oxide fuel cells. In use these seals are typically positioned between two portions of a solid oxide fuel cell stack such as between the cell frame and interconnect as is shown the detailed description below. This double sealing concept provides superior thermal cycling stability in electrochemical devices where gasses must be separated from each other. While this exemplary example has been provided, it is to be distinctly understood that the invention is not limited thereto but maybe variously alternatively embodied according to the needs and necessities of the respective users.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 is a schematic view of a first embodiment of the present invention

FIG. 2 is schematic side view of a portion of a solid oxide fuel showing the placement and location of one embodiment of the present invention having a top plan view of the embodiment of the invention shown in FIG. 1.

FIG. 3 shows a schematic view of a solid oxide fuel cell demonstrating the presence of the seal of the present invention.

FIG. 4 shows the results of testing of one embodiment of the present invention.

### DETAILED DESCRIPTION OF THE INVENTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions. It should be understood, that there is no intention to limit the invention to the specific form disclosed, but, on the contrary, the invention is to cover all modifications, alternative constructions, and equivalents falling within the spirit and scope of the invention as defined in the claims.

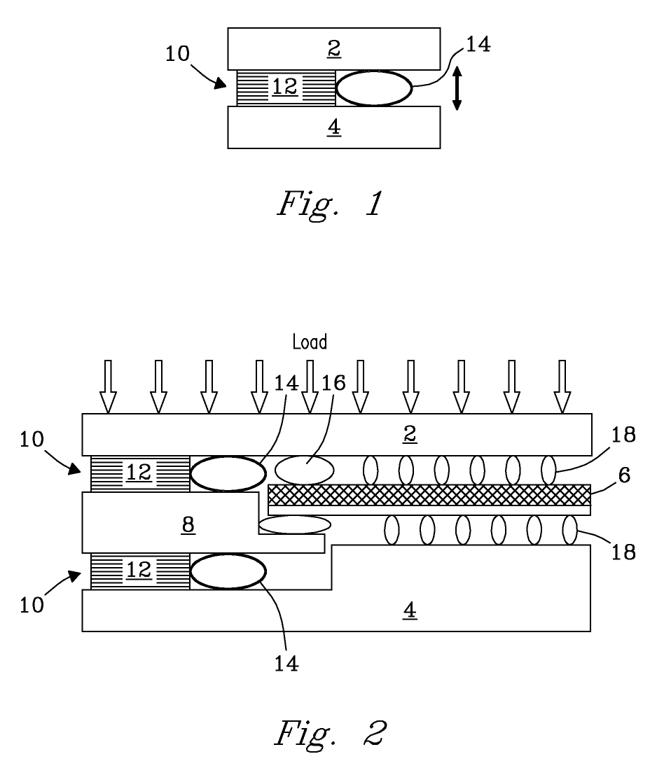

FIGS. 1-2 show various embodiments of the present invention. Referring first to FIG. 1 a schematic of a single cross section of a single cell assembly is shown. In this embodiment, the double seal 10 is comprised of a first sealing material 12 and a second sealing material 14 placed between an interconnect anode 2 and an interconnect cathode 4. In this embodiment of the invention the first sealing material 12 is a compressive sealing material, such as compressive mica such as the one described. The term “mica” encompasses a group of complex aluminosilicate minerals having a layer structure with varying chemical compositions and physical properties. More particularly, mica is a complex hydrous silicate of aluminum, containing potassium, magnesium, iron, sodium, fluorine and/or lithium, and also traces of several other elements. It is stable and completely inert to the action of water, acids (except hydro-fluoric and concentrated sulfuric) alkalis, convention solvents, oils and is virtually unaffected by atmospheric action. Stoichiometrically, common micas can be described as follows:

AB₂₋₃(Al, Si) Si₃O₁₀(F, OH)₂

where A=K, Ca, Na, or Ba and sometimes other elements, and where B=Al, Li, Fe, or Mg. Although there are a wide variety of micas, the following six forms make up most of the common types: Biotite (K₂(Mg, Fe)₂(OH)₂(AlSi₃)₁₀)), Fuchsite (iron-rich Biotite), Lepidolite (LiKAl₂(OH, F)₂(Si₂O₅)₂), Muscovite (KAl₂(OH)₂(AlSi₃O₁₀)), Phlogopite (KMg₃Al(OH)Si₄O₁₀)) and Zinnwaldite (similar to Lepidolite, but iron-rich). Mica can be obtained commercially in either a paper form or in a single crystal form, each form of which is encompassed by various embodiments of the invention. Mica in paper form is typically composed of mica flakes and a binder, such as, for example, an organic binder such as a silicone binder or an epoxy, and can be formed in various thicknesses, often from about 50 microns up to a few millimeters. Mica in single crystal form is obtained by direct cleavage from natural mica deposits, and typically is not mixed with polymers or binders.

In addition to this material a variety of other compressive materials may also be utilized examples of other compressive materials include expanded vermiculite, graphite, and composites containing either or both. The second material is preferably a hermetic sealing material such as a glass material like alkaline earth (Ba, Ca, Sr, Mg) aluminosilicates glasses, borate glasses, silicate glass containing rare earth, or alkali-containing silicate/borate glasses. In addition to glass other hermetic sealing materials including brazes such as precious metal based brazes, brazing materials containing active agent such (copper oxide), or composites containing brazing materials and other materials may also be utilized.

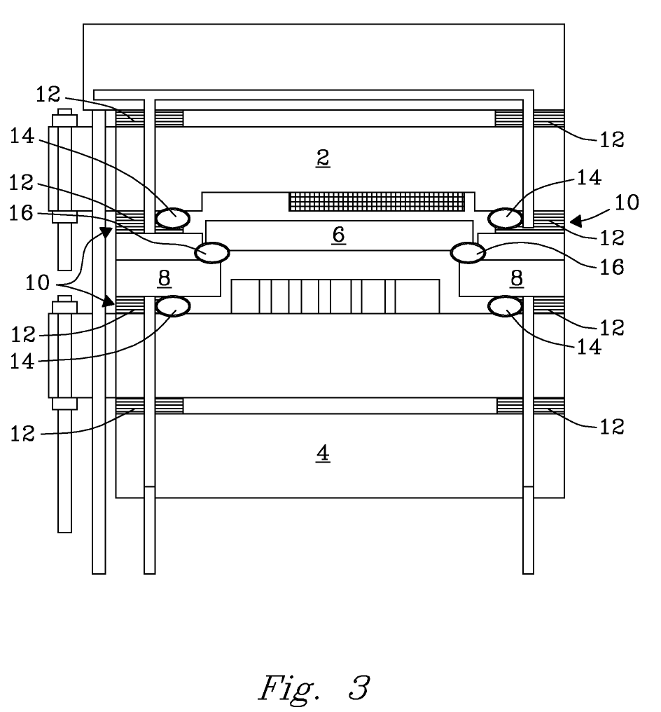

The present invention thus provides high-temperature electrochemical devices such as solid oxide fuel cell (SOFC), solid oxide electrolysis cell (SOEC), gas permeation membranes and others critical seals to separate different gases in the device. Referring now to FIGS. 2 and 3, FIGS. 2 and 3 show schematic drawings of the cross-section view of a repeating unit cell consisting of the interconnect plates 2, 4 (anode and cathode side), a ceramic positive electrode-electrolyte-negative electrode (PEN) plate 6 sealed onto a metallic window-frame plate 8, contact materials 18 at both electrodes, and seals 10. With a standard single seal the failure probability increases substantially, if not proportionally when using only one particular seal at one particular sealing location. However in the present invention the combination of a compressive seal material and a hermetic seal material provides increased advantages in that it protects and supports the seal and keeps the contact (compressive) load in the planar SOFC/SOEC stacks to keep good contact of tens of repeating unit cells in spite of the fact that temperature distribution would not be isothermal throughout the whole stack during transient heating/cooling or even steady-state operations.

The present invention thus overcomes the prior art problems associated with dimensional shrinkage of the sealing materials by creep, plastic deformation or viscous flow especially for glass seal or metallic brazes. This prevents localized opening stress pushing up the ceramic PEN plate from the window-frame plate which typically leads to failure.

In this preferred embodiment of the invention set forth in FIGS. 2 and 3, the seal 10 includes a mica-based compressive seal gasket 12 and a hermetic seal 14 such as glass or brazes at the same sealing location to form the double seal. In addition a dimensional stabilizer 16 such as a crystalline mineral with layer structure and a ceramic material (such as Al2O3, MgO, ZrO2 etc) placed on the other side of the PEN to window-frame seal offers another control to assist with dimensional stability. Together the proposed novel seal assembly offered the best seal system for planar SOFC/SOEC to a much controlled dimensional change, to withstand numerous thermal cycling and long-time operation in a harsh environment

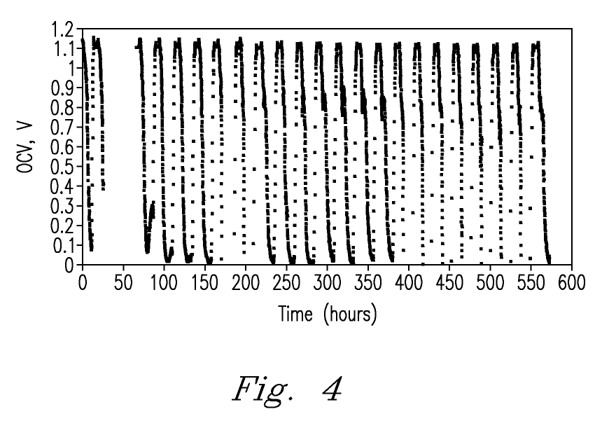

A demonstration of this invention was carried out on a single commercial cell (2″×2″) sealed onto a SS441 window-frame plate with a high-temperature sealing glass. The pre-sealed cell/window-frame couple was then assembled with a SS441 anode plate and a SS441 cathode plate. Conducting contact pastes were also applied at the anode and cathode with the dimensional stabilizer (alumina in paste form) applied on the opposite of the window-frame glass seal. The double seal was composed of a glass seal in paste form along the inner seal circumference and the hybrid mica using phlogopite mica sandwiched between two layers of Ag foil along the outer seal circumference. This single cell “stack” was then sandwiched between two heat-exchanger blocks to pre-heat the incoming fuel and air. The seal between heat-exchanger blocks and the mating electrode plates was hybrid mica with Ag interlayers. The whole assembly was pressed at 10 psi and slowly heated to elevated temperatures by first to 550° C. for binder burn-off, followed by 950° C. for sealing, 800° C. for crystallization, and then to 750° C. for open circuit voltage (OCV) measurement. The fuel was 97% H2 and 3% H2O and the oxidizer was air. The theoretical (Nernst) voltage for this concentration of fuel and air at 750° C. was 1.110 V. The cell's OCV was then monitored versus thermal cycling. The temperature profile for each thermal cycle was heated from room temperature to 750° C. in 3 hrs, held at 750° C. for 3 hrs, and then cooled first in a controlled manner followed by natural furnace cooling. The total period of time for each cycle was 24 hours. The measured OCV versus 25 thermal cycles is shown in FIG. 4. Clearly the current double seal with dimensional control demonstrated the excellent thermal cycle stability with nearly constant OCV of 1.104-1.106V at 750° C.

This invention could well advance the technologies of solid oxide fuel cells, solid oxide electrolysis cells, and gas permeation membranes operated at elevated temperatures and would experience numerous thermal cycling during routine operations. These high-temperature electrochemical devices would be used in stationary power generation as small units or large units, military applications for providing low-noise power in rural or hostile areas, auxiliary power units for transportation applications, and gas separation/generation related chemical industries. The unique advantage is the superior thermal cycle stability over the existing technologies where single seal is used for each particular sealing area.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A seal for SOFC devices characterized by a double seal having a first sealing material having a first preselected characteristic and a second sealing material having a second sealing characteristic.

2. The seal of claim 1 wherein said first sealing material is a compressive sealing material and the second sealing material is a hermetic sealing material.

3. The seal of claim 1 wherein said compressive sealing material is a mica seal and said hermetic sealing material is a glass sealing material.

4. The seal of claim 1 wherein said hermetic sealing material is braze material.

5. The seal of claim 1 further comprising a dimensional stabilizer.

6. The seal of claim 5 wherein said dimensional stabilizer is a metal oxide.

7. The seal of claim 6 wherein said metal oxide has a melting temperature higher than typical SOFC operation temperatures

8. The seal of claim 7 wherein said metal oxide is selected from the group consisting of: is selected from the group consisting of Al2O3, MgO and ZrO2.

9. A solid oxide fuel cell characterized by:
a seal positioned between a first portion and a second portion, said seal comprised of a first sealing material having a first preselected characteristic and a second sealing material having a second sealing characteristic.

10. The solid oxide fuel cell of claim 9 wherein said first sealing material is a compressive sealing material and the second sealing material is a hermetic sealing material.

11. The solid oxide fuel cell of claim 9 wherein said compressive sealing material is a mica seal and said hermetic sealing material is a glass sealing material.

12. The solid oxide fuel cell of claim 10 wherein said hermetic sealing material is a braze material.

13. The solid oxide material of claim 9 further comprising a dimensional stabilizer.

14. The solid oxide fuel cell of claim 13 wherein said dimensional stabilizer is a metal oxide.

15. The solid oxide fuel cell of claim 14 wherein said metal oxide is selected from the group consisting of Al2O3, MgO and ZrO2.

16. A solid oxide fuel cell comprising a seal having a mica-based compressive seal and a hermetic seal forming a double seal; and a dimensional stabilizer to provide dimensional stability.

17. The solid oxide fuel cell of claim 16 wherein said dimensional stabilizer comprises a crystalline mineral with layer structure.

18. The solid oxide fuel cell of claim 17 wherein said dimensional stabilizer further comprises a ceramic material.

19. The solid oxide fuel cell of claim 16 wherein said double seal and said dimensional stabilizer are placed on opposite sides of a PEN to window-frame seal.
